(19) United States
(12) Patent Application Publication
(10) Pub. No.: US 2004/0250425 A1
(43) Pub. Date: Dec. 16, 2004

(54) Utility knife with compression wheel

(76) Inventors: Richard Arent, Menasha, WI (US); Dennis Wordell, Hortinville, WI (US)

Correspondence Address: RICHARD ARENT, 334 WINNEBAGO AVENUE, MENASHA, WI, 54952, US

(21) Appl. No.: 10/336,908

(22) Filed: Jan. 6, 2003

Related U.S. Application Data
(60) Provisional application No. 60/346,703, filed on Jan. 7, 2002.

(51) Int. Cl. B26B 3/00

(52) U.S. Cl. 30/142; 30/123

(57) ABSTRACT

A tool for cutting insulation is comprised of two elongated mating handles connected at a central point. A blade/blade carrier and compression wheel with gear like teeth is supported between the handle halves. An optional releasable locking mechanism in the handle allows the blade to be retracted into the tool. Pulling the tool along the surface of insulation material while applying downward pressure to the compression wheel and blade allows the rotating wheel to grip and compresses the material allowing the blade to make a straight cut without tearing.

### FEDERALLY SPONSORED RESEARCH

Not Applicable

### SEQUENCE LISTING OR PROGRAM

Not Applicable

1. Background/Field of Invention

This invention relates to the process of cutting dense materials like insulation and other deep porous fabrics. Cutting of this type of material can be a very difficult and awkward job.

2. Background/Prior Art

The conventional utility knife (U.S. Pat. Nos. 4,524,518 and 5,301,428) is the typical method of cutting these materials however due to the looseness and compressibility of these materials, several passes of the knife is usually required for a complete cut-threw. In some cases the user will place a straight edged flat object such as a board along the cut line to help compress the material prior to cutting.

Adaptations of traditional utility knife designs (U.S. Pat. Nos. 6,122,831 and 5,075,974) have in their own way focused on the specific needs of cutting dense porous materials.

This invention substantially departs from all prior utility knife concepts by introducing a unique apparatus (the compression wheel) which delivers several advantages over existing art.

### SUMMARY

The central point of difference between the prior utility knifes and the present invention is a compression wheel that grips and compresses the cutting material prior to coming in contact with the cutting blade.

Because compressed material is easier to cut the user is assured an easier, more accurate and cleaner cut.

Advantages

The utility knife with compression wheel offers the following advantages over traditional prior art.

1. The user is assured an easier cut as less pressure will be required to cut compressed material.

2. The user is assured of a more accurate cut. With less play in the cutting material there is a decrease in cutting variance. In addition the gripping teeth help keep the cut straight.

3. The user of assured of a cleaner cut.

4. The user is assured of a safer cut. Less downward pressure results in more control.

5. The user has more versatility. The tool is not limited to heavy material and as such can be used on other materials.

6. The user will have less waste due to cutting errors.

### DRAWINGS /DESCRIPTIONS

FIG. 1. A side profile of the present invention.

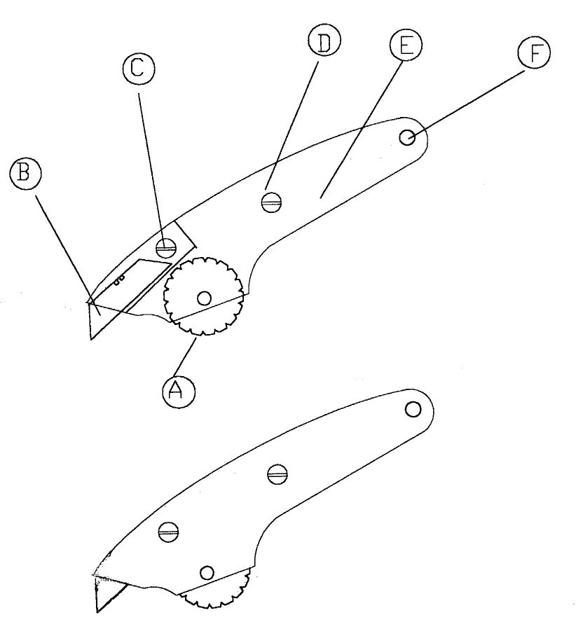

A. The compression wheel.

B. The cutting blade.

C. The screw used to disengage the cutting blade.

D. The screw used to disengage the magazine.

E. The handle.

F. The hole for hanging.

G. Not shown, an optional retractable blade.

### MATERIALS

The present invention can be made out of a variety of materials depending on the needs of the different market segments. Construction materials could include but are not limited to hardened rubber, plastic, aluminum or steel components. Reference information necessary for the tools' function and branding can be stamped, printed or communicated with secondary materials.

Operation

Step 1. The user grasps the handle with fingers on the finger rest and the thumb on the thumb rest.

Step 2. The user places the cutting blade and compression wheel evenly on the surface to be cut and applies downward pressure.

Step 3. The user pulls the tool back along the cutting line, allowing the compression wheel and teeth to grip and compress the cutting material prior to having contact with the blade.

1. An apparatus for cutting dense porous material comprising:
A housing device having a first end and a second end adapted to hold a retractable cutting blade at the first end;
a compression wheel with gripping teeth;
the compression wheel rotatably coupled to the housing device proximate the first end thereof.
